(19) United States
(12) Patent Application Publication
(10) Pub. No.: US 2025/0192965 A1
(43) Pub. Date: Jun. 12, 2025

(54) BASE STATION AND WIRELESS COMMUNICATION METHODS OF INTER-CELL COORDINATION SIGNALING REDUCTION FOR CLI MITIGATION

(71) Applicant: TCL COMMUNICATION TECHNOLOGY (CHENGDU) LIMITED, Chengdu (CN)

(72) Inventors: Shahid JAN, Chengdu (CN); Jia SHENG, Chengdu (CN)

(73) Assignee: TCL COMMUNICATION TECHNOLOGY (CHENGDU) LIMITED, Chengdu (CN)

(21) Appl. No.: 18/844,956

(22) PCT Filed: Mar. 7, 2022
(86) PCT No.: PCT/CN2022/079603

§ 371 Date: Sep. 7, 2024

(51) Int. Cl. H04L 5/00; H04L 5/14; H04W 72/541

(52) U.S. Cl. CPC H04L 5/0073; H04L 5/0048; H04L 5/0092; H04L 5/1469; H04W 72/541

(57) ABSTRACT

A base station and wireless communication methods of inter-cell coordination signaling reduction for cross link interference (CLI) mitigation in dynamic time division duplex (TDD) are disclosed. The wireless communication method performed by the base station includes exchanging an assistance information with a plurality of neighbor/adjacent base stations based on a master-slave base station model, an inter-cell cluster information exchange, an information exchange above a threshold value, or an offline information exchange, wherein the assistance information comprises a downlink (DL)/uplink (UL) configuration information, a scheduling information, a traffic information, a CLI measurement report, and/or a sounding reference signal (SRS) measurement.

### BACKGROUND OF DISCLOSURE

### 1. Field of the Disclosure

The present disclosure relates to the field of wireless communication systems, and more particularly, to a base station and wireless communication methods of inter-cell coordination signaling reduction for cross link interference (CLI) mitigation in dynamic time division duplex (TDD).

### 2. Description of the Related Art

Dynamic TDD improves the spectral efficiency, reduces the latency through flexible configuration of downlink link (DL)/uplink (UL) traffic, and efficiently utilizes time resources. However, in dynamic TDD, a neighbor/adjacent cell may use the same spectrum (frequency band) in the same time slots and different transmission directions can create CLI.

Most of the companies support to exchange an assistance information among base stations for CLI mitigation in dynamic TDD. However, there is no concreate study and proposal in Release-15/16 on how to reduce a backhaul signaling for the assistance information exchange among different base stations.

Therefore, there is a need for a base station and wireless communication methods of inter-cell coordination signaling reduction for CLI mitigation in dynamic TDD.

### SUMMARY

An object of the present disclosure is to propose a base station and wireless communication methods of inter-cell coordination signaling reduction for cross link interference (CLI) mitigation in dynamic time division duplex (TDD), which can solve issues in the prior art, reduce an additional information exchange and the number of backhaul signaling, reduce information exchange complexity, reduce latency, prevent CLI before happening, with a possible low latency, provide a good communication performance, and/or provide high reliability.

In a first aspect of the present disclosure, a wireless communication method of inter-cell coordination signaling reduction for CLI mitigation in dynamic TDD, performed by a base station includes exchanging an assistance information with a plurality of neighbor/adjacent base stations based on a master-slave base station model, an inter-cell cluster information exchange, an information exchange above a threshold value, or an offline information exchange, wherein the assistance information comprises a downlink (DL)/uplink (UL) configuration information, a scheduling information, a traffic information, a CLI measurement report, and/or a sounding reference signal (SRS) measurement.

In a second aspect of the present disclosure, a wireless communication method of CLI mitigation in dynamic TDD, performed by a base station includes performing a timing advancement and timing delay execution, wherein the base station and the neighbor/adjacent base stations are grouped into a cluster or group of base stations, and the cluster or group of base stations identifies a DL/UL configuration status or a CLI status of a transmission channel.

In a third aspect of the present disclosure, a base station comprises a memory, a transceiver, and a processor coupled to the memory and the transceiver. The processor is configured to exchange an assistance information with a plurality of neighbor/adjacent base stations based on a master-slave base station model, an inter-cell cluster information exchange, an information exchange above a threshold value, or an offline information exchange, wherein the assistance information comprises a downlink (DL)/uplink (UL) configuration information, a scheduling information, a traffic information, a CLI measurement report, and/or a sounding reference signal (SRS) measurement.

In a fourth aspect of the present disclosure, a base station comprises a memory, a transceiver, and a processor coupled to the memory and the transceiver. The processor is configured to perform a timing advancement and timing delay execution, wherein the base station and the neighbor/adjacent base stations are grouped into a cluster or group of base stations, and the cluster or group of base stations identifies a DL/UL configuration status or a CLI status of a transmission channel.

In a fifth aspect of the present disclosure, a non-transitory machine-readable storage medium has stored thereon instructions that, when executed by a computer, cause the computer to perform the above method.

In a sixth aspect of the present disclosure, a chip includes a processor, configured to call and run a computer program stored in a memory, to cause a device in which the chip is installed to execute the above method.

In a seventh aspect of the present disclosure, a computer readable storage medium, in which a computer program is stored, causes a computer to execute the above method.

In an eighth aspect of the present disclosure, a computer program product includes a computer program, and the computer program causes a computer to execute the above method.

In a ninth aspect of the present disclosure, a computer program causes a computer to execute the above method.

### BRIEF DESCRIPTION OF DRAWINGS

In order to illustrate the embodiments of the present disclosure or related art more clearly, the following figures will be described in the embodiments are briefly introduced. It is obvious that the drawings are merely some embodiments of the present disclosure, a person having ordinary skill in this field can obtain other figures according to these figures without paying the premise.

FIG. 1 is a schematic diagram illustrating an example of a fixed DL/UL configuration.

FIG. 2 is a schematic diagram illustrating an example of a dynamic DL/UL configuration.

FIG. 3 is a schematic diagram illustrating an example of a CLI in dynamic TDD.

FIG. 4 is a block diagram of base stations (e.g., gNBs) of communication in a communication network system according to an embodiment of the present disclosure.

FIG. 5 is a flowchart illustrating a wireless communication method of inter-cell coordination signaling reduction for CLI mitigation in dynamic TDD, performed by a base station according to an embodiment of the present disclosure.

FIG. 6 is a flowchart illustrating a wireless communication method of CLI mitigation in dynamic TDD, performed by a base station according to an embodiment of the present disclosure.

FIG. 7 is a schematic diagram illustrating an example of a legacy way of assistance information exchange for CLI mitigation.

FIG. 8 is a schematic diagram illustrating an example of master/slave model for assistance information exchange for CLI mitigation according to an embodiment of the present disclosure.

FIG. 9 is a schematic diagram illustrating an example of inter cluster assistance information exchange for CLI mitigation according to an embodiment of the present disclosure.

FIG. 10 is a schematic diagram illustrating an example of timing advancement and timing delay calculation according to an embodiment of the present disclosure.

FIG. 11 is a schematic diagram illustrating an example of execution of timing advance and delay for DL and UL cell according to an embodiment of the present disclosure.

FIG. 12 is a schematic diagram illustrating an example of execution of timing advancement timing delay in DL and UL for cell-cluster according to an embodiment of the present disclosure.

FIG. 13 is a block diagram of a system for wireless communication according to an embodiment of the present disclosure.

### DETAILED DESCRIPTION OF EMBODIMENTS

Embodiments of the present disclosure are described in detail with the technical matters, structural features, achieved objects, and effects with reference to the accompanying drawings as follows. Specifically, the terminologies in the embodiments of the present disclosure are merely for describing the purpose of the certain embodiment, but not to limit the disclosure.

The diversified use cases and exponential growth of number of UEs in the next generation wireless communication system has increased the data traffic explosively which leads to the high requirements of wireless communication system, such as high data rate and spectral efficiency. In order to satisfy these requirements, several methods have been studied and adopted in the next generation wireless communication system, such as millimeter wave (mmWave) spectrum for wider bandwidth, transmission, and reception through Multiple Input Multiple Output (MIMO) and enhancement of Signal to Interference plus Noise Ratio (SINR) to mitigate the interference. In addition, efficient utilization of the available spectrum is one of the basic requirements for the next generation wireless communication system. For this purpose, duplex operation has been adopted by 4G LTE wireless communication system.

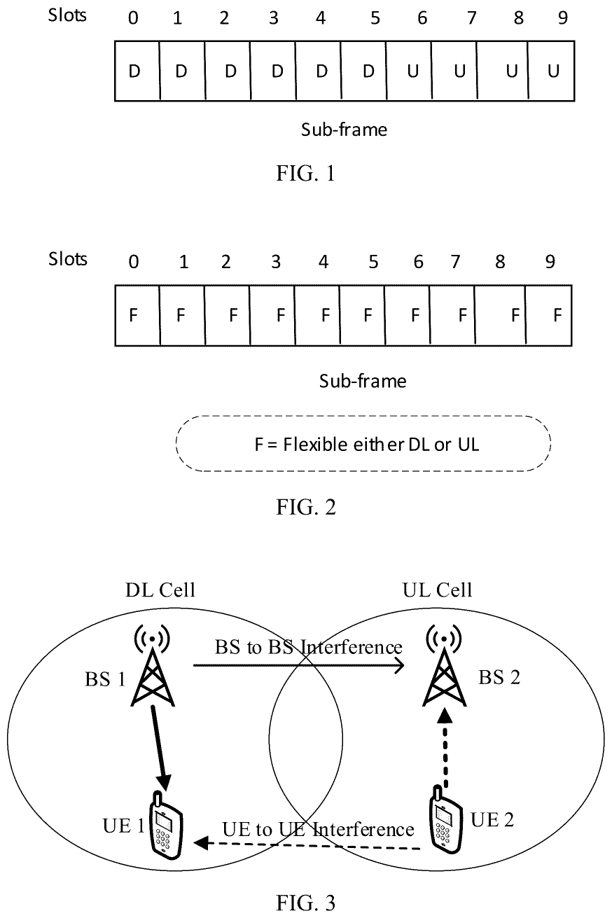

In duplex operation, two modes of transmission i.e., frequency division duplex (FDD) and TDD are used. In FDD, two different spectrums (frequency bands) are used for Downlink (DL) and Uplink (UL) data transmission in a single cell. In TDD, a single spectrum (frequency band) is used for DL and UL in different time slots. TDD has the advantage of high spectral efficiency as compared to the FDD. However, conventional TDD uses fixed/static configuration of DL and UL sub frames of the same frequency band which leads to the ineffective time resources utilization and increases the latency especially in a case when the DL and UL traffic are not the same. For instance, consider a cell with only DL transmission and fixed TDD configuration as shown in FIG. 1. Since the time slots configuration is fixed, hence the cell can only use the time slots which are configured for DL, while the cell cannot use the time slots which are configured for UL. Consequently, the static/fixed TDD wastes the time slots resources and increases the transmission latency.

In 5G NR system, dynamic/flexible TDD transmission has been studied and adopted, in which the DL and UL time slots are configured according to the traffic adaptation. In other words, the configuration of the DL and UL time slots in a cell is not fixed and it can be configured according to the DL or UL traffic as shown in FIG. 2. Dynamic TDD efficiently utilize the time slots resources and reduce the latency. However, dynamic/flexible TDD inherit a serious issue of cross link interference (CLI) which occurs due to different transmission direction of the same frequency in the neighbor cells. For instance, consider two cells operating with the same frequency bands at the same time but in different direction, i.e., cell 1 is operating in DL direction and cell 2 is operating in UL direction as shown in FIG. 3. In the DL, BS2 receives the cross link interference from the BS1, known as BS-to-BS interference. In the UL, UE2 receives the cross link interference from UE1, known as UE-to-UE interference.

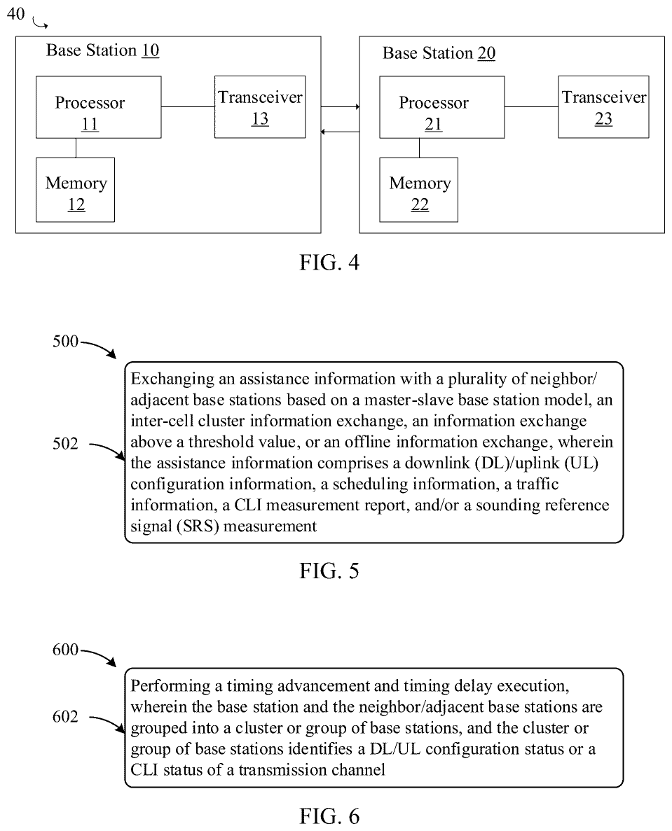

FIG. 4 illustrates that, in some embodiments, base stations (e.g., gNBs) 10 and 20 for communication in a communication network system 40 according to an embodiment of the present disclosure are provided. The communication network system 40 includes the base stations 10 and 20 (such as a first base station 10 and one or more second base stations 20). The base station 10 may include a memory 12, a transceiver 13, and a processor 11 coupled to the memory 12 and the transceiver 13. The base station 20 may include a memory 22, a transceiver 23, and a processor 21 coupled to the memory 22 and the transceiver 23. The processor 11 or 21 may be configured to implement proposed functions, procedures and/or methods described in this description. Layers of radio interface protocol may be implemented in the processor 11 or 21. The memory 12 or 22 is operatively coupled with the processor 11 or 21 and stores a variety of information to operate the processor 11 or 21. The transceiver 13 or 23 is operatively coupled with the processor 11 or 21, and the transceiver 13 or 23 transmits and/or receives a radio signal.

The processor 11 or 21 may include application-specific integrated circuit (ASIC), other chipset, logic circuit and/or data processing device. The memory 12 or 22 may include read-only memory (ROM), random access memory (RAM), flash memory, memory card, storage medium and/or other storage device. The transceiver 13 or 23 may include baseband circuitry to process radio frequency signals. When the embodiments are implemented in software, the techniques described herein can be implemented with modules (e.g., procedures, functions, and so on) that perform the functions described herein. The modules can be stored in the memory 12 or 22 and executed by the processor 11 or 21. The memory 12 or 22 can be implemented within the processor 11 or 21 or external to the processor 11 or 21 in which case those can be communicatively coupled to the processor 11 or 21 via various means as is known in the art.

In some embodiments, the processor 11 is configured to exchange an assistance information with a plurality of neighbor/adjacent base stations 20 based on a master-slave base station model, an inter-cell cluster information exchange, an information exchange above a threshold value, or an offline information exchange, wherein the assistance information comprises a downlink (DL)/uplink (UL) configuration information, a scheduling information, a traffic information, a CLI measurement report, and/or a sounding reference signal (SRS) measurement. This can solve issues in the prior art, reduce an additional information exchange and the number of backhaul signalings, reduce information exchange complexity, reduce latency, prevent CLI before happening, with a possible low latency, provide a good communication performance, and/or provide high reliability.

In some embodiments, the processor 11 is configured to perform a timing advancement and timing delay execution, wherein the base station 10 and the neighbor/adjacent base stations 20 are grouped into a cluster or group of base stations, and the cluster or group of base stations identifies a DL/UL configuration status or a CLI status of a transmission channel. This can solve issues in the prior art, reduce an additional information exchange and the number of backhaul signalings, reduce information exchange complexity, reduce latency, prevent CLI before happening, with a possible low latency, provide a good communication performance, and/or provide high reliability.

FIG. 5 illustrates a wireless communication method 500 of inter-cell coordination signaling reduction for CLI mitigation in dynamic TDD, performed by a base station according to an embodiment of the present disclosure. In some embodiments, the method 500 includes: a block 502, exchanging an assistance information with a plurality of neighbor/adjacent base stations based on a master-slave base station model, an inter-cell cluster information exchange, an information exchange above a threshold value, or an offline information exchange, wherein the assistance information comprises a downlink (DL)/uplink (UL) configuration information, a scheduling information, a traffic information, a CLI measurement report, and/or a sounding reference signal (SRS) measurement. This can solve issues in the prior art, reduce an additional information exchange and the number of backhaul signalings, reduce information exchange complexity, reduce latency, prevent CLI before happening, with a possible low latency, provide a good communication performance, and/or provide high reliability.

In some embodiments, the assistance information is exchanged between the base station and the neighbor/adjacent base stations using a layer 1 (L1) signaling or a radio resource control (RRC) signaling through an Xn interface. In some embodiments, the L1 signaling comprises a bitmap used to exchange the DL/UL configuration information or the scheduling information in a slot or a subframe, and/or the RRC signaling is used to exchange the traffic information, the CLI measurement report, or the SRS measurement. In some embodiments, the base station and the neighbor/adjacent base stations are grouped into a cluster or group of base stations, the master-slave base station model is used within the cluster or the group of base stations to exchange the assistance information, one base station of the cluster or the group of base stations is a master base station, and the other base stations of the cluster or the group of base stations are salve base stations. In some embodiments, in the master-slave base station model, the slave base stations exchange the assistance information with the master base station, and the master base station calculates and tabulates the assistance information of the entire base stations within a cluster or a group of base stations into a table and shares the table with the salve base stations.

In some embodiments, the base station and the neighbor/adjacent base stations are grouped into a plurality of clusters or groups of base stations comprising a first cluster or group of base stations and a second cluster or group of base stations, the inter-cell cluster information exchange is used within the clusters or the groups of base stations to exchange the assistance information. In some embodiments, in the inter-cell cluster information exchange, the first cluster or group of base stations is configured in a DL direction, the second cluster or group of base stations is configured in an UL direction, and the assistance information is exchanged between the first cluster or group of base stations and the second cluster or group of base stations. In some embodiments, the assistance information is exchanged between a master base station of the first cluster and a master base station of the second cluster. In some embodiments, the master base station of the first cluster or group of base stations exchanges an information of a DL/UL traffic direction of the assistance information with the salve base stations of the first cluster or group of base stations, and/or the master base station of the second cluster or group of base stations exchanges the information of the DL/UL traffic direction of the assistance information with the salve base stations of the second cluster or group of base stations.

In some embodiments, the base station and the neighbor/adjacent base stations are grouped into a cluster or group of base stations, the information exchange above the threshold value is used within the cluster or the group of base stations, and the information exchange above the threshold value defines the threshold value for a DL or UL traffic and shares the assistance information between the cluster or the group of base stations above the threshold value. In some embodiments, the threshold value is equal to X and is defined in terms of slots or sub frames, where a value of X is in a range of X equal to {1, 2, 3, 4, 5, 6, 7, 8, 9, 10} slots or sub frames. In some embodiments, when the DL or UL traffic of a user equipment (UE) in a cell is above the threshold value, the assistance information is exchanged between the cluster or the group of base stations. In some embodiments, when the DL or UL traffic of the UE in the cell is below the threshold value, the assistance information is not exchanged between the cluster or the group of base stations.

In some embodiments, the base station and the neighbor/adjacent base stations are grouped into a cluster or group of base stations, the offline information exchange is used within the cluster or the group of base stations, and the offline information exchange is used in a scenario where UEs are static in a cell, and a DL dominant or UL dominant data traffic is transmitted or receive in a time. In some embodiments, the assistance information of a static UE is shared by each serving base station with neighbor base stations or a master base station of the cluster or the group of base stations. In some embodiments, the master base station of the cluster or the group of base stations calculates and tabulates the assistance information and shares offline with neighbor/adjacent slave base stations of the cluster or the group of base stations.

FIG. 6 illustrates a wireless communication method 600 of CLI mitigation in dynamic TDD, performed by a base station according to an embodiment of the present disclosure. In some embodiments, the method 600 includes: a block 602, performing a timing advancement and timing delay execution, wherein the base station and the neighbor/adjacent base stations are grouped into a cluster or group of base stations, and the cluster or group of base stations identifies a DL/UL configuration status or a CLI status of a transmission channel. This can solve issues in the prior art, reduce an additional information exchange and the number of backhaul signalings, reduce information exchange complexity, reduce latency, prevent CLI before happening, with a possible low latency, provide a good communication performance, and/or provide high reliability.

In some embodiments, the wireless communication method further comprises that before the base station performs the timing advancement and timing delay execution, the base station performs an inter-cell coordination and/or sensing. In some embodiments, in the inter-cell coordination, the cluster or group of base stations exchanges the DL/UL configuration information. In some embodiments, in the sensing, the cluster or group of base stations uses reference signals to know the CLI status of neighbor/adjacent cells or to identify if there are links in different transmission directions.

In some embodiments, in the timing advancement and timing delay execution, a timing advancement is calculated from a propagation delay of a slot or sub frame from the base station to the UE, where the timing advancement is equal to 2 times of the propagation delay of a slot or sub frame by the following equation, TA=2×TP, where TA is the timing advancement and TP is the propagation delay of the slot or the sub frame from the base station to the UE. In some embodiments, in the timing advancement and timing delay execution, a timing delay is calculated by the following equation, TD=TO−TP, where TD is the timing delay, TO is a time offset of a slot or sub frame, and TP is a propagation delay of the slot or sub frame from the UE to the base station.

In some embodiments, in the timing advancement and timing delay execution, the inter-cell coordination or sensing based method is used for information exchange between the neighbor/adjacent cells to execute the timing advancement or timing delay in the neighbor/adjacent cells in the cluster or group of base stations. In some embodiments, in the timing advancement and timing delay execution, for the timing advancement, initiated by a medium access control (MAC) layer, is used by a DL cell, and the timing delay, initiated by the MAC layer and conveyed by a physical layer to an UL UE is used by an UL cell. In some embodiments, a DL slot or sub frame of the base station arrives to the UE before a transmission of a UL slot or sub frame in the neighbor/adjacent cell.

In some embodiments, in the timing advancement and timing delay execution, the cluster or group of base stations comprises a first cluster or group of base stations and a second cluster or group of base stations, the first cluster or group of base stations is configured in a DL direction and the second cluster or group of base stations is configured in an UL direction. In some embodiments, the timing advancement is applied to the first cluster or group of base stations and the timing delay is applied to the second cluster or group of base stations. In some embodiments, DL slots or sub frames of the first cluster or group of base stations arrive to DL UEs before a transmission of UL slots or sub frames in the second cluster or group of base stations.

Some embodiments of this disclosure are related to the dynamic time division duplex (TDD) in 5G NR communication system. More specifically, some embodiments of this disclosure focus on the inter-cell coordination based backhaul signaling reduction for the cross link interference (CLI) mitigation in dynamic TDD. Some embodiments of this disclosure propose several schemes to reduce the backhaul signaling for the assistance information exchange among the base stations, and a CLI mitigation scheme. Some embodiments discuss the assistance information exchange signaling reduction solutions. Some embodiments discuss a timing advancement and timing delay based CLI mitigation scheme.

### Inter-Cell Coordination Signaling Reduction Schemes:

In dynamic TDD, inter-cell coordination is used for CLI mitigation, in which the adjacent/neighbor base stations exchange the assistance information among each other through Xn interface, where the assistance information may comprise DL/UL configuration information, scheduling information, traffic information, CLI measurement report, or sounding reference signal (SRS) measurement. This information exchange, increases the backhaul signaling, introduces latency and increases complexity especially in dense deployment scenarios. In order to reduce the backhaul signaling for this information exchange among the neighbor base stations or a cluster of base stations, this section of the present disclosure discuss the following solutions.

In addition, this disclosure considers L1 signaling or RRC signaling to exchange the assistance information among the cluster or group of base stations through Xn interface. L1 signaling such as bitmap can be used to exchange the DL/UL configuration, or scheduling information of a slot or subframe. For instance, consider a DL/UL slot format of 10 slots or subframe. The information DL/UL slot format can be indicated by using 10 bits, where each bit indicates the DL/UL format of each slot, and this bitmap can be exchange among the neighbor/adjacent base stations through L1 signaling. Similarly, RRC signaling can be used to exchange the information of CLI measurement report, SRS measurement, or traffic information.

### Master-Slave Base Stations:

This embodiment of the present disclosure presents a first method of backhaul signaling reduction, where the assistance information is exchanged among the base stations in a cluster or a group of neighbor base stations, and the assistance information may comprise DL/UL configuration information, scheduling information, traffic information, CLI measurement report, or SRS measurement. In this exemplarily method, a master-slave model is used within a cluster of base stations or a group of neighbor base stations to exchange the assistance information among the base stations, in which one base station is assigned as a master base station and the other base stations are assigned as slave base stations. In master-slave base stations model, the slave base stations exchange the assistance information with the master BS, and the master base station calculate and tabulate the assistance information of the entire base stations within a cluster and share this table with the salve base stations. Consequently, the master-slave base station model reduces the backhaul signaling which are used for the assistance information exchange among the base stations. The advantage of this method is to minimize the repetitive information exchange shared by each BS with its neighbor/adjacent base station within a cluster or a group of neighbor base stations.

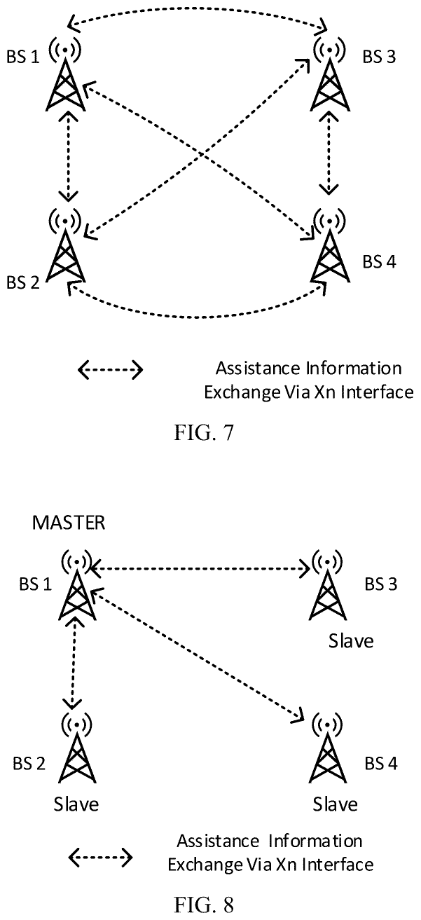

FIG. 7 is a schematic diagram illustrating an example of a legacy way of assistance information exchange for CLI mitigation. FIG. 8 is a schematic diagram illustrating an example of master/slave model for assistance information exchange for CLI mitigation according to an embodiment of the present disclosure. For instance, consider four BSs in a cluster, as shown in FIG. 7 and FIG. 8. In FIG. 7, the assistance information exchange among the base stations in the legacy way, e.g., each base station exchanges its assistance information with its neighbor base station, and the whole cluster of base stations consume 12 backhaul signaling through Xn interface. On the other hand, as shown in FIG. 8, in the master slave model, the slave base station exchanges the assistance information with the master base station and the master base station can tabulate this information, as shown in table 1, and share back with every slave base stations. Here the number of backhaul signaling used for the assistance information exchange between the master BS and slave base stations are 4, in which 3 signaling are used by slave base station to exchange the information with the master BS and one signaling is used by master BS to exchange the whole cluster assistance information to all the slave BSs. Consequently, in this example the master-slave model reduces the assistance information exchange and backhaul signaling by three times as compared to the legacy way.

TABLE 1
Example of assistance information tabulate and share
by Master BS with the slave BSs

| Base stations | BS1 (Master) | BS2 (Slave) | BS3 (Slave) | BS4 (Slave) |
|---|---|---|---|---|
| Assistance | BS1 | BS2 | BS3 | BS4 |
| Information | Information | Information | Information | Information |

### Inter-Cell Cluster Information Exchange:

This embodiment of the present disclosure proposes a second method of backhaul signaling reduction, where the assistance information are exchanged between the clusters of base stations, and the assistance information may comprises of; the DL/UL configuration information, scheduling information, traffic information, CLI measurement report, or SRS measurement. In this exemplarily method, a cluster of base station is configured either in DL or UL direction, and the assistance information of the DL and UL cell clusters are exchanged in a way that, the master base stations of one cluster exchange the assistance information with the master base station of another cluster. The master base station of each cluster can exchange the assistance information with their slave base stations within a cluster. In this way, the backhaul signaling for the information exchange among different base stations reduces as compared to the legacy way, in which each base station of one cluster share its assistance information with each other base station another cluster.

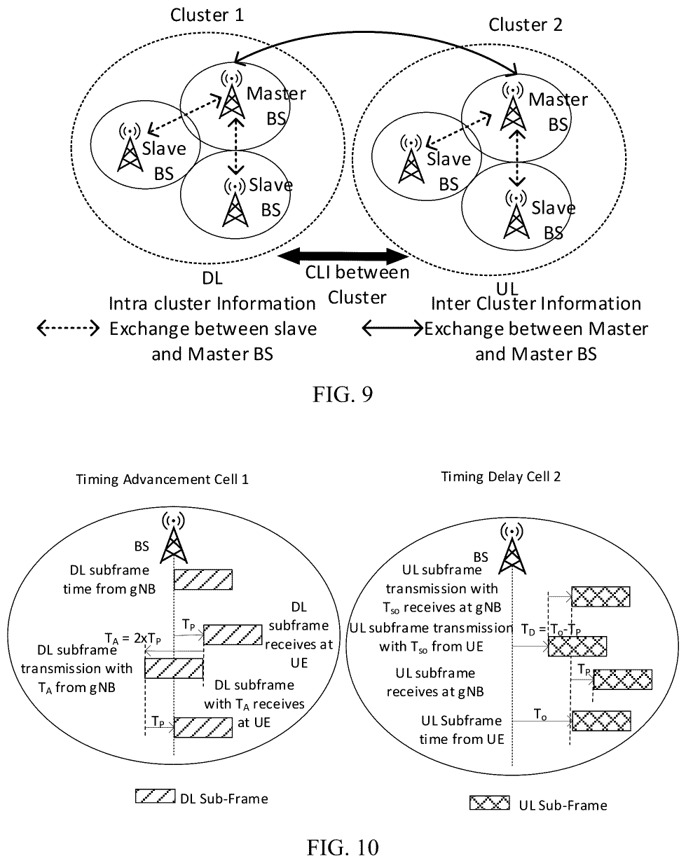

FIG. 9 is a schematic diagram illustrating an example of inter cluster assistance information exchange for CLI mitigation according to an embodiment of the present disclosure. For instance, consider two cluster: cluster 1, and cluster 2. The base stations of cluster 1 are configured in DL direction and the base stations of cluster 2 are configured in UL direction as shown in FIG. 9. In order to avoid the CLI between the clusters, cluster 1 base stations need to exchange the assistance information with cluster 2 base stations. The assistance information can be exchange between the master base stations of cluster 1 and the master base station of cluster 2. The Master BSs of each cluster can further exchange the information of the DL/UL traffic direction with their respective slave BSs.

### Information Exchange Above a Threshold Value:

This embodiment of the present disclosure proposes a third method of backhaul signaling reduction, where the assistance information is exchanged among the base stations in a cluster or a group of neighbor base stations, and the assistance information may comprise the DL/UL configuration information, or traffic information. This exemplarily method defines a certain threshold for the DL or UL traffic and share the assistance information among the cluster or group of neighbor/adjacent base stations above the threshold. The threshold value X can be defined in terms of slots or sub-frames, where the value of X can be in the range of X={1, 2, 3, 4, 5, 6, 7, 8, 9, 10} slots or sub-frames.

In this exemplarily solution, when the DL or UL traffic of a UE in a cell is above the threshold value, the assistance information will be exchange among the base stations within a cluster or a group of neighbor's base stations. In addition, when the DL or UL traffic of a UE in a cell is below the threshold value, the assistance information will not be exchange among the base stations. This exemplarily method is beneficial in targeting those scenarios where the DL or UL traffic of UEs are very small. For instance, the traffic of the industrial wireless sensors, which is mainly DL dominant, and size of its transport block is very small. In addition, the traffic of the industrial actuators is mainly UL dominant control related functions, and the size of its transport block is very small. Thus, the very small transport block may accommodate in a single slot/sub-frame, or few sub-frames and it may not create CLI in the neighbor cells. Therefore, establishing a certain threshold of the assistance information exchange for such scenarios are helpful in backhaul signaling reduction.

### Offline Information Exchange of Static UEs:

In this embodiment of the present disclosure, a fourth method of backhaul signaling reduction is proposed, where the assistance information is exchanged among the base stations in a cluster or a group of neighbor base stations, and the assistance information may comprises of; the DL/UL configuration information, scheduling information, traffic information, CLI measurement report, or SRS measurement.

In this exemplarily method, the assistance information exchange offline among the neighbor base stations or a cluster of base stations, which help to reduce the real time online signaling for the information exchange among the base stations. This exemplarily method mostly targets those scenarios where the UEs are static in a cell and transmit or receive the DL dominant or UL dominant data traffic in a certain time. For instance, the video surveillance traffic is UL dominant and transmitted in a certain time. Similarly, the industrial wireless sensors/actuators are DL dominant and transmitted in a certain time. Each serving base station can share the assistance information of a static UE with its neighbor base stations or master base station within a cluster or group of neighbor base stations. The master base station can calculate and tabulate the assistance information and share offline with the adjacent slave base stations.

To explain the offline information exchange, let consider a scenario of static UEs where the DL or UL traffic flow at certain time period. Since the UEs are static and the traffic has only two directions either DL or UL, thus each base station can assign a bit value of “1” or “0” to the DL or UL traffic respectively and share this information with the master base station. The master base station can tabulate this information across the time period and share it with all its slave base station within a cluster or group of base stations. An example of static traffic information exchange is shown in table 2. Since each base station within a cluster or group of neighbor/adjacent base station have the static UE's traffic information of the neighbor/adjacent base station. Therefore, each base station can adjust the DL or UL traffic according to the offline information and there is no need for a base station to exchange real time information. Consequently, the online information exchange among the adjacent/neighbor base stations reduces significantly.

TABLE 2
Offline Static Traffic Information Exchange

| Time Period | BS 1 | BS 2 | BS 3 |
|---|---|---|---|
| Time period 1 | 1 | 1 | 0 |
| Time period 2 | 0 | 1 | 1 |
| Time period 3 | 1 | 0 | 0 |
| Time Period 4 | 1 | 0 | 1 |

### Timing Advancement and Timing Delay CLI Mitigation Scheme:

Dynamic TDD efficiently utilize the time slots resources and reduces the latency. However, dynamic/flexible TDD inherit severe issues of cross-link interference (CLI) which occurs due to of the same frequency in different direction in the adjacent neighbor cells. To solve this issue this section of the present disclosure proposes a timing advancement and timing delay scheme for CLI mitigation. In this scheme, the adjacent cells in a cluster of base stations or group of base stations need to early identify the DL/UL configuration status of each other or the CLI status of the transmission channel. For this purpose, the cluster or group of base stations can perform one of the following two actions before executing this scheme.
1. Inter-cell coordination: Pre Inter-cell coordination is necessary before executing the time advancement and timing delay in the adjacent cells, in which the adjacent base stations in a cluster or group of base stations exchange the assistance information such as DL/UL configuration.
2. Sensing: Pre-sensing is required before executing the timing advancement and timing delay scheme, in which the adjacent base stations using reference signals to know the CLI status of the adjacent cells or to identify if there are links in different transmission direction.

### Timing Advancement and Timing Delay Calculation:

FIG. 10 is a schematic diagram illustrating an example of timing advancement and timing delay calculation according to an embodiment of the present disclosure. For the timing advancement the existing timing control procedure, initiated by the MAC layer, such as timing advance offset N_{TA} as defined in current specification [38.211] can be consider as a baseline to calculate the timing advancement for the DL cell as shown in FIG. 7. Reference to FIG. 10, the timing advancement can be calculated from the propagation delay of a slot or a sub-frame from base station to the UE, where the timing advancement is equal to 2 times of the propagation delay of a slot/sub-frame as given by the following equation.

T_{A}=2×T_{P}, where T_{A} is the timing advancement and T_{P} is the slot or sub-frame propagation delay from the base station to the UE.

Similarly, for timing delay, a time offset of slot or sub-frame and propagation delay is used. As shown in cell 2 of FIG. 10, the timing delay can be calculated by the following equation.

T_{D}=T_{O}−T_{P}, where T_{D} is the timing delay, T_{O} is the time offset of a slot or sub-frame and T_{P} is the propagation delay of a slot or sub-frame from UE to the base station.

### Timing Advancement and Timing Delay Execution:

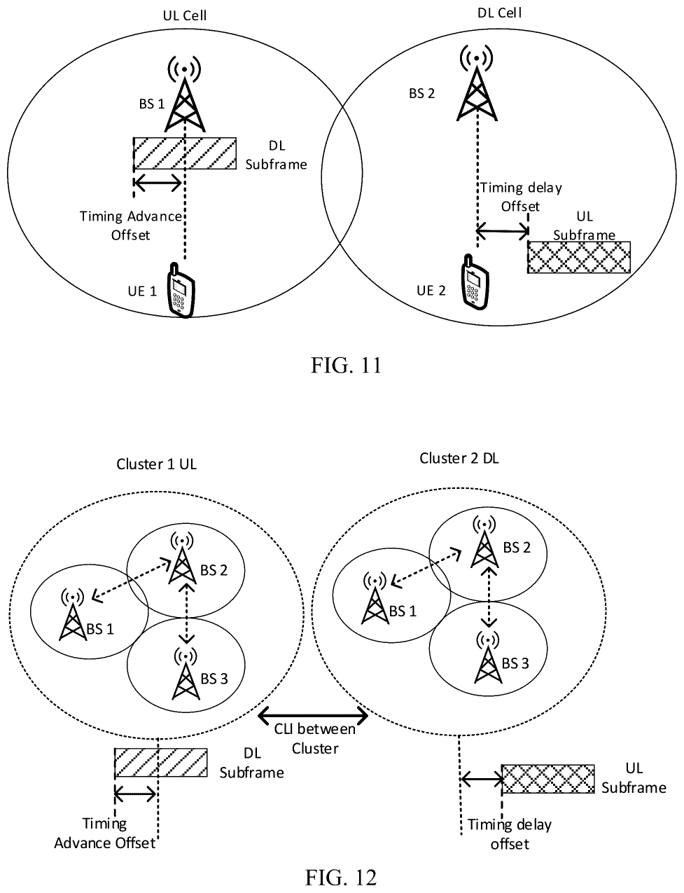

In order to execute the timing advancement or timing delay in the adjacent cells in a cluster or group of base stations, the aforementioned inter-cell coordination or sensing based method can be used for information exchange between the adjacent cells. Since the adjacent cells are familiar with the transmission direction of each other or the CLI status of the link, it can execute the timing delay and timing advancement scheme. FIG. 11 is a schematic diagram illustrating an example of execution of timing advance and delay for DL and UL cell according to an embodiment of the present disclosure. For the timing advancement, initiated by the MAC layer, can be used by the DL cell and the timing delay, initiated by the MAC layer, and conveyed by the physical layer to the UL UE can be used by the UL cell as shown in FIG. 11. In this way, the DL slot or sub-frames of base station arrives to the destination (UE) before the transmission of the UL slot or sub-frame in the neighbor cell and thus it mitigates the CLI from happening.

FIG. 12 is a schematic diagram illustrating an example of execution of timing advancement timing delay in DL and UL for cell-cluster according to an embodiment of the present disclosure. Similarly, the cluster of base stations can also use the timing advancement and timing delay scheme to the DL and UL cluster. For instance, a cluster 1 of base stations is configured in the DL direction and a cluster 2 of base stations is configured in the UL direction as shown in FIG. 12. The timing advancement is applied to the DL cluster 1 and the timing delay is applied to the UL cluster 2. In this way, the DL slots or sub-frames of cluster 1 arrives to the DL UEs before the transmission of the UL slots or sub-frames in the adjacent UL cluster 2. Consequently, it can avoid the inter-cluster CLI before happening.

In summary, the main objectives of some embodiments of this disclosure are to mitigate the CLI in dynamic TDD and reduce the backhaul signaling which is used for the assistance information exchange among the adjacent/neighbor base stations. The proposed solutions to achieve the objectives are summarized as below. Several methods have proposed to reduce the backhaul signaling which are used for the assistance information exchange among the neighbor/adjacent base stations, such as master-slave base station model, inter-cell cluster information exchange method, Information exchange above a certain threshold value, or offline information exchange. Timing advancement and timing delay scheme has introduced to mitigate the CLI before happening in dynamic TDD.

This disclosure proposes several methods to reduce the backhaul signaling, which are used for the assistance information exchange among the base stations to mitigate CLI in dynamic TDD, and have the following advantages:

1. The proposed solutions of the assistance information exchange for CLI mitigation in dynamic TDD can reduce the additional information exchange and the number of backhaul signalings.

2. The proposed solutions of the assistance information exchange among the base stations reduce the information exchange complexity.

3. The proposed solutions of the assistance information exchange among the base stations reduce the latency.

4. The timing advancement and timing delay solution of CLI mitigation can prevent the CLI before happening, with the possible low latency.

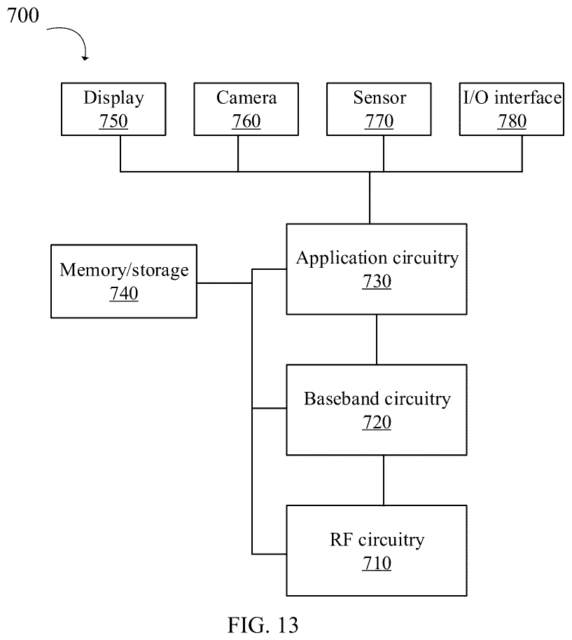

FIG. 13 is a block diagram of an example system 700 for wireless communication according to an embodiment of the present disclosure. Embodiments described herein may be implemented into the system using any suitably configured hardware and/or software. FIG. 13 illustrates the system 700 including a radio frequency (RF) circuitry 710, a baseband circuitry 720, an application circuitry 730, a memory/storage 740, a display 750, a camera 760, a sensor 770, and an input/output (I/O) interface 780, coupled with each other at least as illustrated. The application circuitry 730 may include a circuitry such as, but not limited to, one or more single-core or multi-core processors. The processors may include any combination of general-purpose processors and dedicated processors, such as graphics processors, application processors. The processors may be coupled with the memory/storage and configured to execute instructions stored in the memory/storage to enable various applications and/or operating systems running on the system.

While the present disclosure has been described in connection with what is considered the most practical and preferred embodiments, it is understood that the present disclosure is not limited to the disclosed embodiments but is intended to cover various arrangements made without departing from the scope of the broadest interpretation of the appended claims.

1. A wireless communication method of inter-cell coordination signaling reduction for cross link interference (CLI) mitigation, performed by a base station, comprising:
exchanging an assistance information with a plurality of neighbor/adjacent base stations based on a master-slave base station model, an inter-cell cluster information exchange, an information exchange above a threshold value, or an offline information exchange, wherein the assistance information comprises a downlink (DL)/uplink (UL) configuration information, a scheduling information, a traffic information, a CLI measurement report, and/or a sounding reference signal (SRS) measurement.

2. The wireless communication method according to claim 1, wherein the assistance information is exchanged between the base station and the neighbor/adjacent base stations using a layer 1 (L1) signaling or a radio resource control (RRC) signaling through an Xn interface.

3. The wireless communication method according to claim 2, wherein the L1 signaling comprises a bitmap used to exchange the DL/UL configuration information or the scheduling information in a slot or a subframe, and/or the RRC signaling is used to exchange the traffic information, the CLI measurement report, or the SRS measurement.

4. The wireless communication method according to claim 1, wherein the base station and the neighbor/adjacent base stations are grouped into a cluster or group of base stations, the master-slave base station model is used within the cluster or the group of base stations to exchange the assistance information, one base station of the cluster or the group of base stations is a master base station, and the other base stations of the cluster or the group of base stations are salve base stations.

5. The wireless communication method according to claim 4, wherein in the master-slave base station model, the slave base stations exchange the assistance information with the master base station, and the master base station calculates and tabulates the assistance information of the entire base stations within a cluster or a group of base stations into a table and shares the table with the salve base stations.

6. The wireless communication method according to claim 1, wherein the base station and the neighbor/adjacent base stations are grouped into a plurality of clusters or groups of base stations comprising a first cluster or group of base stations and a second cluster or group of base stations, the inter-cell cluster information exchange is used within the clusters or the groups of base stations to exchange the assistance information.

7. The wireless communication method according to claim 6, wherein in the inter-cell cluster information exchange, the first cluster or group of base stations is configured in a DL direction, the second cluster or group of base stations is configured in an UL direction, and the assistance information is exchanged between the first cluster or group of base stations and the second cluster or group of base stations.

8. The wireless communication method according to claim 7, wherein the assistance information is exchanged between a master base station of the first cluster and a master base station of the second cluster.

9. The wireless communication method according to claim 8, wherein the master base station of the first cluster or group of base stations exchanges an information of a DL/UL traffic direction of the assistance information with the salve base stations of the first cluster or group of base stations, and/or the master base station of the second cluster or group of base stations exchanges the information of the DL/UL traffic direction of the assistance information with the salve base stations of the second cluster or group of base stations.

10. The wireless communication method according to claim 1, wherein the base station and the neighbor/adjacent base stations are grouped into a cluster or group of base stations, the information exchange above the threshold value is used within the cluster or the group of base stations, and the information exchange above the threshold value defines the threshold value for a DL or UL traffic and shares the assistance information between the cluster or the group of base stations above the threshold value.

11-16. (canceled)

17. A wireless communication method of CLI mitigation in dynamic TDD, performed by a base station, comprising:
performing a timing advancement and timing delay execution, wherein the base station and the neighbor/adjacent base stations are grouped into a cluster or group of base stations, and the cluster or group of base stations identifies a DL/UL configuration status or a CLI status of a transmission channel.

18. The wireless communication method according to claim 17, further comprising before the base station performs the timing advancement and timing delay execution, the base station performs an inter-cell coordination and/or sensing.

19. The wireless communication method according to claim 18, wherein in the inter-cell coordination, the cluster or group of base stations exchanges the DL/UL configuration information.

20. The wireless communication method according to claim 18, wherein in the sensing, the cluster or group of base stations uses reference signals to know the CLI status of neighbor/adjacent cells or to identify if there are links in different transmission directions.

21. The wireless communication method according to claim 18, wherein in the timing advancement and timing delay execution, a timing advancement is calculated from a propagation delay of a slot or sub frame from the base station to the UE, where the timing advancement is equal to 2 times of the propagation delay of a slot or sub frame by the following equation, TA=2×TP, where TA is the timing advancement and TP is the propagation delay of the slot or the sub frame from the base station to the UE.

22. The wireless communication method according to claim 18, wherein in the timing advancement and timing delay execution, a timing delay is calculated by the following equation, TD=TO−TP, where TD is the timing delay, TO is a time offset of a slot or sub frame, and TP is a propagation delay of the slot or sub frame from the UE to the base station.

23. The wireless communication method according to claim 18, wherein in the timing advancement and timing delay execution, the inter-cell coordination or sensing based method is used for information exchange between the neighbor/adjacent cells to execute the timing advancement or timing delay in the neighbor/adjacent cells in the cluster or group of base stations.

24. The wireless communication method according to claim 18, wherein in the timing advancement and timing delay execution, for the timing advancement, initiated by a medium access control (MAC) layer, is used by a DL cell, and the timing delay, initiated by the MAC layer and conveyed by a physical layer to an UL UE is used by an UL cell.

25. The wireless communication method according to claim 24, wherein a DL slot or sub frame of the base station arrives to the UE before a transmission of a UL slot or sub frame in the neighbor/adjacent cell.

26-28. (canceled)

29. A base station, comprising:
a memory;
a transceiver; and
a processor coupled to the memory and the transceiver;
wherein the processor is configured to:
exchange an assistance information with a plurality of neighbor/adjacent base stations based on a master-slave base station model, an inter-cell cluster information exchange, an information exchange above a threshold value, or an offline information exchange, wherein the assistance information comprises a downlink (DL)/uplink (UL) configuration information, a scheduling information, a traffic information, a CLI measurement report, and/or a sounding reference signal (SRS) measurement; or
perform a timing advancement and timing delay execution, wherein the base station and the neighbor/adjacent base stations are grouped into a cluster or group of base stations, and the cluster or group of base stations identifies a DL/UL configuration status or a CLI status of a transmission channel.

30-34. (canceled)
